(19) United States
(12) Patent Application Publication
(10) Pub. No.: US 2016/0146571 A1
(43) Pub. Date: May 26, 2016

(54) Multi-Axis Swivel Connector

(71) Applicant: RA Brands, L.L.C., Madison, NC (US)

(72) Inventors: Robert Michael Howard, Acworth, GA (US); Michael Ross Snyder, Madison, AL (US); Jeffrey Brian Still, Virginia Beach, VA (US)

(21) Appl. No.: 14/944,757

(22) Filed: Nov. 18, 2015

Related U.S. Application Data
(60) Provisional application No. 62/082,847, filed on Nov. 21, 2014.

(51) Int. Cl. F41C 23/02; F16C 11/06

(52) U.S. Cl. CPC F41C 23/02; F16C 11/06

(57) ABSTRACT

A multi-axis swivel connector defines rotational axes between parts of the multi-axis swivel connector. Some of the rotational axes can extend cross-wise to one another. Some of the rotational axes can define adjustable inclination angles between parts of the multi-axis swivel connector. Parts of the swivel connector can be respectively configured for at least partially facilitating connections with articles such as a sling and a firearm.

### CROSS-REFERENCE TO RELATED APPLICATION

The present Patent Application is a formalization of previously filed, co-pending U.S. Provisional Patent Application Ser. No. 62/082,847, filed Nov. 21, 2014 by the inventors named in the present Application. This Patent Application claims the benefit of the filing date of this cited Provisional Patent Application according to the statutes and rules governing provisional patent applications, particularly 35 U.S.C. §119(e), and 37 C.F.R. §§1.78(a)(3) and 1.78(a)(4). The specification and drawings of the Provisional Patent Application referenced above are specifically incorporated herein by reference as if set forth in their entirety.

### FIELD OF INVENTION

The present disclosure generally relates to swivel type connectors and, in particular, to a swivel connector that may be used to connect a strap to an object such as, but not limited to, a firearm.

### BACKGROUND OF INVENTION

The ability to easily carry objects such as rifles without having to hold the objects in one's hands has long been a need for persons such as hunters, sportsmen and soldiers. For example, a rifle may include a traditional two-point sling that is attached adjacent to the barrel of the firearm and at another point, typically along the stock of the firearm. Such a traditional two-point sling also can function as a carrying strap that allows the user to carry the firearm on his shoulder with his hands free.

In contrast to a two-point sling, a single-point sling attaches to a firearm at a single-point, such as near the midpoint of the rifle. A single-point sling may be used to support a rifle in front of an user's body in a manner that seeks to allow the user to quickly transition the rifle from a hands-free position to a firing position, or between various firing positions.

It is known for the attachment points between slings and firearms to incorporate swivel connectors. Whereas a variety of swivel connectors are known, there is a desire for a swivel connector that provides a new balance of properties.

### BRIEF SUMMARY

Briefly described, the present disclosure is directed to a multi-axis swivel connector that can optionally be used to connect a sling strap to a firearm. The multi-axis swivel connector can include two, three, or more rotational axes between parts of the multi-axis swivel connector. In one embodiment, at least some of the rotational axes can extend cross-wise to one another and/or define one or more adjustable inclination angles between parts of the multi-axis swivel connector.

One aspect of this disclosure is the provision of a swivel connector that can include at least first, second, third and fourth parts; and at least first, second and third connections, located between the parts of the swivel connector. The first connection can be positioned between the first and second parts of the swivel connector, and configured so that there can be relative rotation between the first and second parts about a first axis of rotation. The second connection can be positioned between the second and third parts of the swivel connector, and configured so that there can be relative rotation between the second and third parts about a second axis of rotation. The first and second axes can extend crosswise to one another. The third connection can be positioned between the third and fourth parts of the swivel connector, and configured so that there can be relative rotation between the third and fourth parts about a third axis of rotation. The second and third axes also can extend crosswise to one another.

The first part of the swivel connector further can comprise a fastener configured to indirectly connect to an article, while the fourth part can be configured to be at least indirectly connected to a sling. In one embodiment, the first part can comprise a quick-disconnect fastener configured to be selectively releasably connectable to a mounting receptacle, which mounting receptacle can be connected to, or can be part of, an object such as a firearm, or the like. The quick-connect fastener can include a ball-detent structure, with outwardly biased protrusions or balls, and an actuator configured to cause the protrusions or balls to become at least partially retractable into a body of the first part. For example, the balls of the quick-connect fastener can be configured to be selectively removably received in an annular groove of the mounting receptacle, and the annular groove can be configured generally as a ball race for allowing the balls to roll therein. The fourth part of the swivel connector additionally can comprise a loop configured to be at least indirectly connected to a sling, such as a sling for a firearm.

Various objects, features and advantages of the present invention will become apparent to those skilled in the art upon a review of the following detail description, when taken in conjunction with the accompanying drawings.

### BRIEF DESCRIPTION OF THE DRAWINGS

FIG. 1 is a perspective view of a multi-axis swivel in a first configuration, in accordance with an embodiment of this disclosure.

FIG. 2A is a front elevation view of the swivel of FIG. 1 in the first configuration.

FIG. 2B is a schematic view of the swivel of FIG. 1 attached to a firearm and a sling in one embodiment.

FIG. 3 is a right elevation view of the swivel of FIG. 1.

FIG. 4 is a bottom plan view of the swivel of FIG. 1.

FIG. 5 is a perspective view of the swivel of FIG. 1.

FIG. 6 is a front elevation view of the swivel of FIG. 5.

FIG. 7 is a rear elevation view of the swivel of FIG. 5.

FIG. 8 is a right elevation view of the swivel of FIG. 5.

FIG. 9 is an isolated, right, top perspective view of a base of the swivel of FIGS. 1-8.

FIG. 10 is an isolated, top perspective view of a bracket of the swivel of FIGS. 1-8.

FIG. 11 is an isolated, bottom perspective view the bracket of FIG. 10.

FIG. 12 is an isolated, top perspective view of a link of the swivel of FIGS. 1-8.

FIG. 13 is an isolated, bottom perspective view of the link of the swivel of FIG. 12.

FIGS. 14 and 15 are perspective, exploded views of a further embodiment of a multi-axis swivel according to the principles of the present invention.

Those skilled in the art will appreciate and understand that, according to common practice, the various features of the drawings discussed below are not necessarily drawn to scale, and that the dimensions of various features and elements of the drawings may be expanded or reduced to more clearly illustrate the embodiments of the present invention described herein.

### DETAILED DESCRIPTION

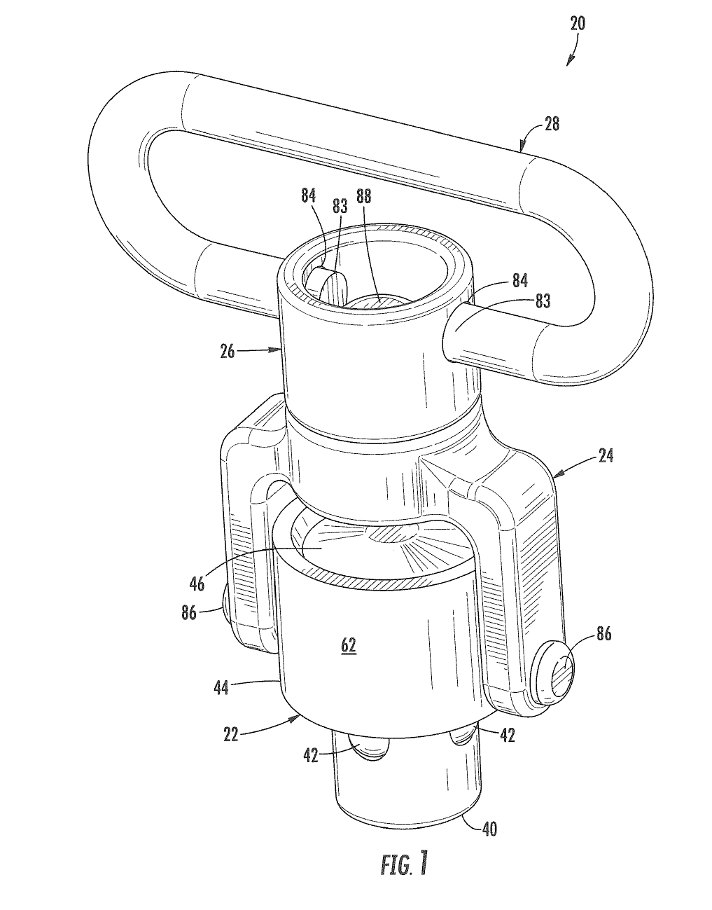

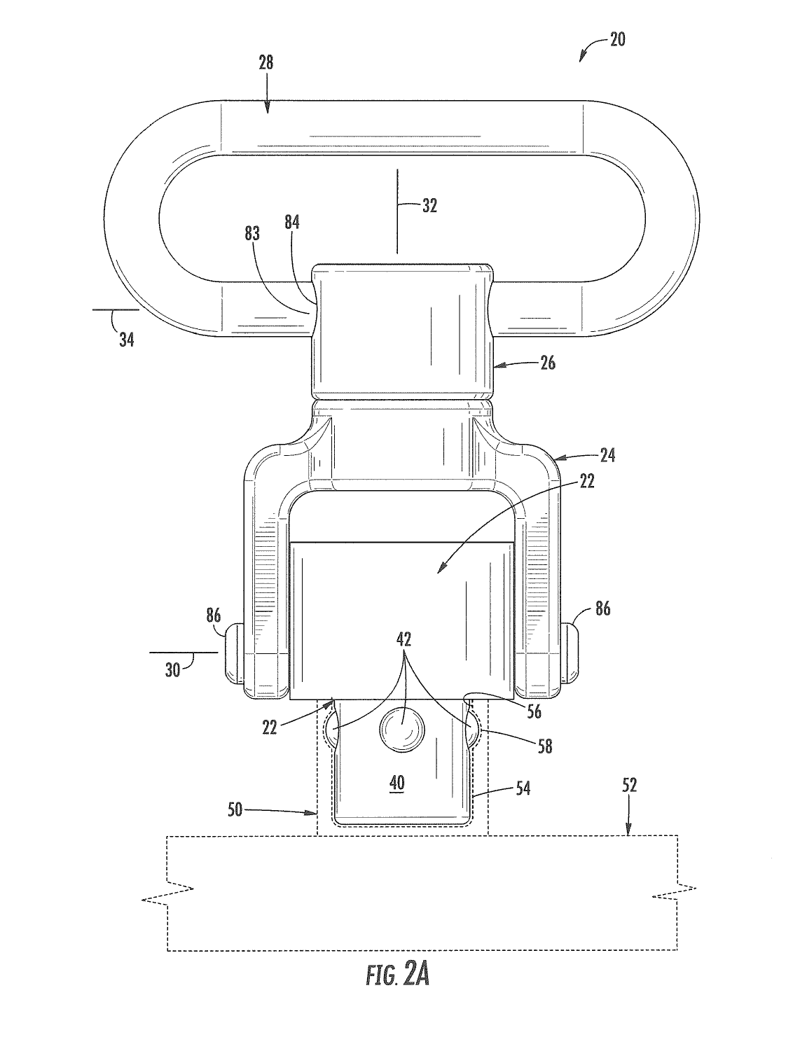

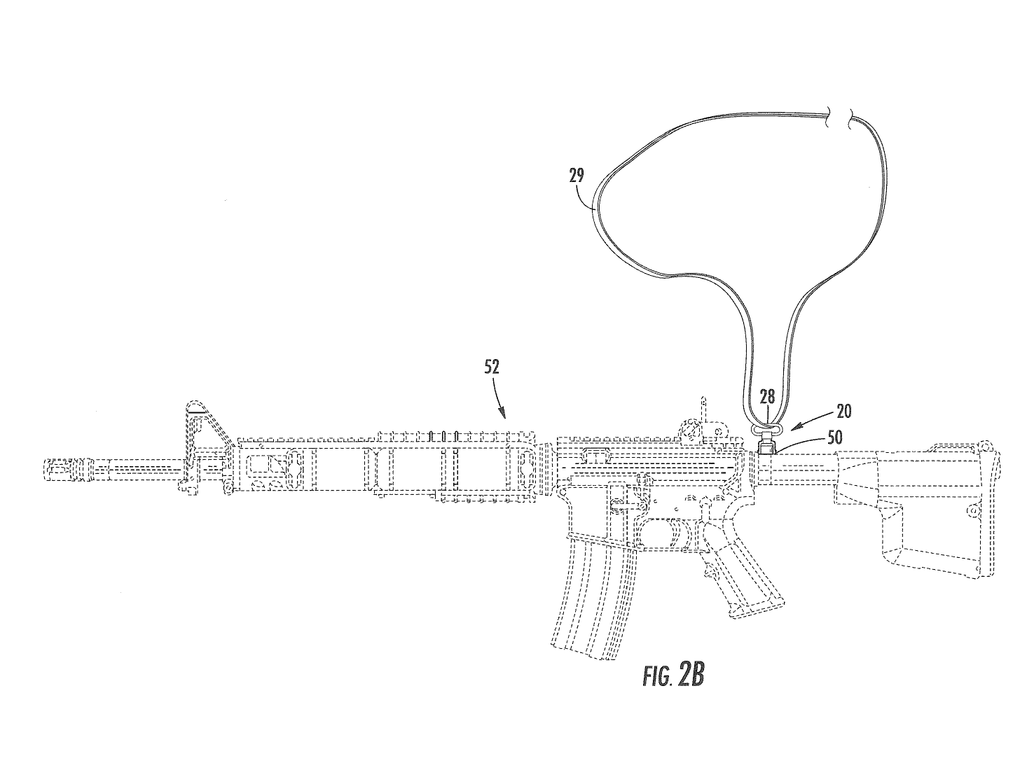

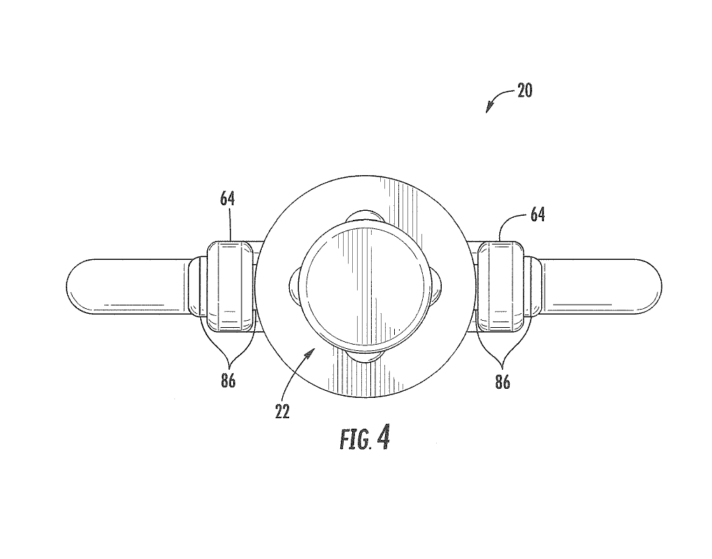

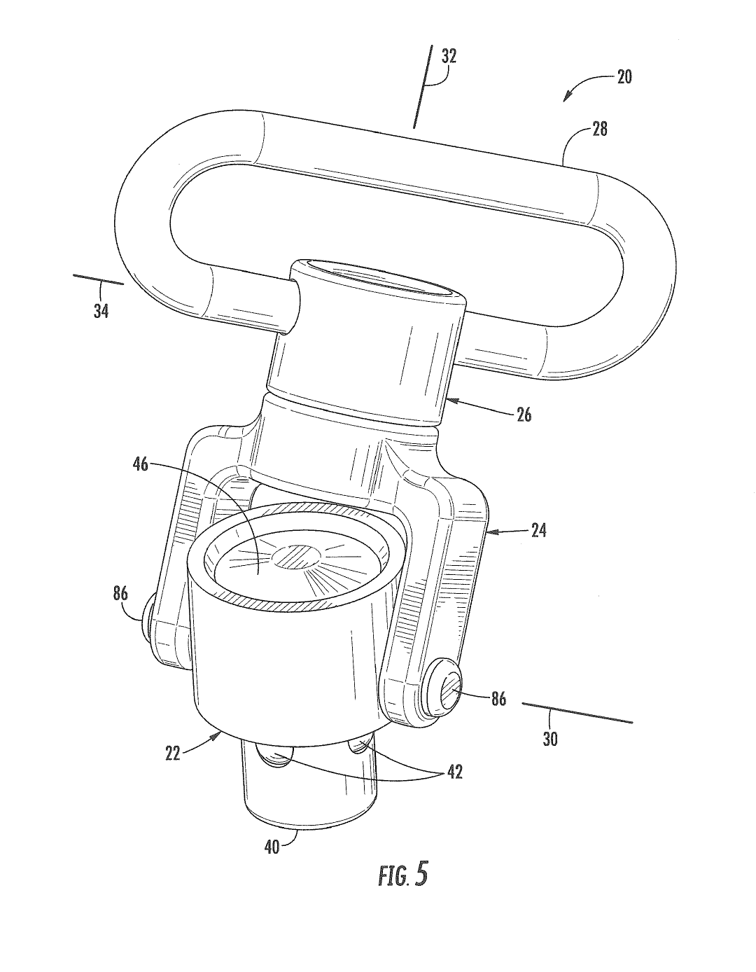

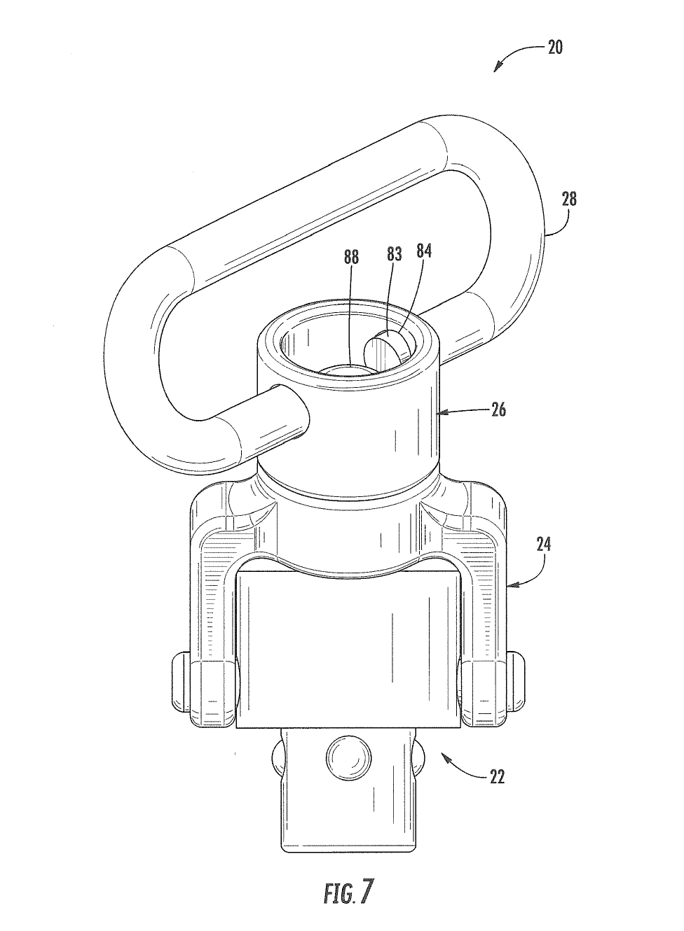

Referring now to the drawings in which like numerals indicate like parts throughout the several views, the present invention is generally directed to a multi-axis swivel connector that can be used to connect a strap to an object such as, but not limited to, a firearm, as shown in FIG. 2B. As examples, and not for the purpose of limiting the scope of the present invention, embodiments of the multi-axis swivel connector 20 that are shown in the drawings of FIGS. 1-15. FIGS. 1-8 illustrate an example embodiment of a multi-axis swivel connector 20 that can be advantageously used, for example, to connect a single-point sling 29 (FIG. 2B) to a firearm 52 (FIG. 2B). However, it will be understood that the principles of the present invention are not restricted to being associated with firearm slings, but rather have wide ranging applicability. For example, the multi-axis swivel connector 20, and/or portions thereof, can be used in a variety of situations to provide a swivel connection between a variety of different articles.

Referring to FIGS. 1 and 2A, the multi-axis swivel connector 20 can include four main parts 22, 24, 26, 28 that can be respectively movably connected to one another. However, there can be a greater or lesser number of main parts. For ease of understanding, and not for the purpose of limiting the scope of this disclosure, the parts 22, 24, 26, 28 can be respectively referred to as a first part or base 22, a second part or bracket 24, a third part or link 26, and a fourth part or loop 28. The base 22 and bracket 24 can be movably connected to one another by at least one first connection, the bracket 24 and link 26 can be movably connected to one another by at least one second connection, and the link 26 and loop 28 can be movably connected to one another by at least one third connection. Each of the first, second and third connections can be a pivotable or otherwise movable connection. For example and referring to FIG. 2A, the first connection can be configured so that there can be relative rotation between the base 22 and bracket 24 about a first or inner transverse axis of rotation 30. The second connection can be configured so that there can be relative rotation between the bracket 24 and link 26 about a second or longitudinal axis of rotation 32. In addition, the third connection can be configured so that there can be relative rotation between the link 26 and loop 28 about a third or outer transverse axis of rotation 34.

In the following, a general discussion of the three above-mentioned pivotable connections will be followed by a detailed discussion of structures of the pivotable connections, wherein the detailed discussion is at times directed to an example embodiment as shown in the drawings. However, there further can be a greater or lesser number of the pivotable connections and associated rotational axes, and the pivotable connections of the embodiments shown in the drawings can be replaced with any other suitable pivotable connections. That is, those of ordinary skill in the art will understand that numerous variations are within the scope of this disclosure.

In a first configuration of the swivel connector 20 shown in FIGS. 1-4, the axes 30, 32, 34 extend in substantially the same plane; the transverse axes 30, 32 extend substantially parallel to one another; and the transverse axes 30, 32 each extend crosswise to, or more specifically substantially perpendicularly to, the longitudinal axis 32. In contrast, FIGS. 5-8 illustrate the swivel connector 20 in a second configuration, in which there has been relative rotation between the parts 22, 24, 26, 28 about each of the axes 30, 32, 34. The swivel connector 20 can be configured in numerous other configurations in response to relative pivoting about one or more of the axes 30, 32, 34.

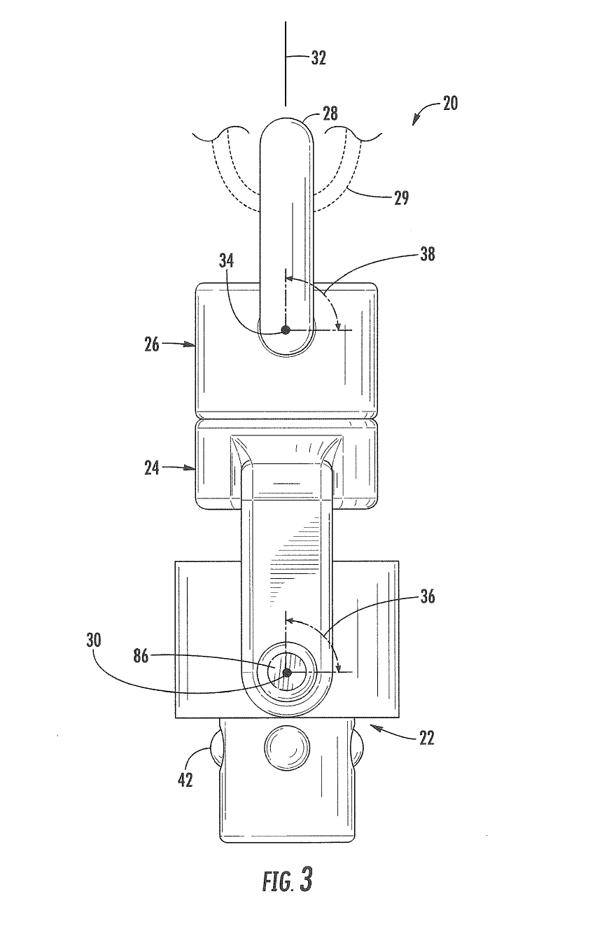

In the embodiments shown in the drawings, for example with reference to FIG. 3, inclination angles 36, 38 can be defined between respective pairs of the parts 22, 24, 26, 28, and the magnitude of the inclination angles can vary in response to pivoting about the transverse axes 30, 34, respectively. The inclination angles 36, 38 are schematically represented by arcuate, double-ended arrows in FIG. 3. In one embodiment, the connection between the base 22 and bracket 24 can be configured so that the inclination angle 36 is defined between the base and the bracket, and the inclination angle 36 extends in a plane that is crosswise to, or more specifically substantially perpendicular to, the inner transverse axis 30. Additionally, the connection between the bracket 24 and link 26 can be configured so that the link is pivotable with the bracket about the inner transverse axis 30 relative to the base 22. Still further, the connection between the link 26 and loop 28 can be configured so that inclination angle 38 is defined between the link and loop, the loop is pivotable relative to the link about the outer transverse axis 34, and the inclination angle 38 extends in a plane that is crosswise to, or more specifically is substantially perpendicular to, the outer transverse axis 34.

In one example, the swivel connector 20 can be configured so that each of the inclination angles 36, 38 can be adjusted (e.g., varied by respectively pivoting about the transverse axes 30, 34) through at least about one hundred and eighty degrees, but less than three hundred and sixty degrees. That is, the swivel connector 20 can be configured so that the magnitude of each of the inclination angles 36, 38 can be varied within a range extending from about zero degrees to at least about one hundred and eighty degrees but less than three hundred and sixty degrees, although other ranges are within the scope of this disclosure. In contrast and in one example, the swivel connector 20 can be configured so that relative rotation abort the longitudinal axis 32 between the bracket 24 and link 26 can be unlimited (e.g., relative rotation of at least, or exceeding, three hundred and sixty degrees is allowed about the second axis between the bracket and link).

Referring to FIG. 3, the loop 28 can be configured so that an article 29, for example, but not limited to, a sling strap or clip fastener carabiner, etc., can be received through a hole that is at least partially defined by and surrounded by the loop, wherein the clip fastener can be connected to a sling strap. Such a sling strap, clip fastener, or the like, can be commercially-available, conventional articles, at least portions of which are shown in FIGS. 2A, 2B and 3.

Referring to FIG. 2A, the base 22 can include, or be generally in the form of, a male quick-disconnect fastener mechanism configured for coupling with a female mounting socket or receptacle 50. The mounting receptacle 50 can be mounted to, or integrally formed with, an article 52 such as, but not limited to, a firearm, as shown in FIG. 2B. The mounting receptacle 50 and firearm 52 are schematically represented by dashed lines in FIG. 2A, and they can be commercially-available, conventional articles. The mounting receptacle 50 can include an outwardly open, substantially cylindrically-shaped mounting cavity at least partially defined by cylindrical walls 54, 56 and an annular groove 58 that extend coaxially around the mounting cavity, wherein the annular groove is positioned between, and has a larger diameter than, the cylindrical walls.

The quick-disconnect fastener mechanism of the base 22 can include a nose 40 and outwardly biased members such as protruding members, bearings or balls 42 that protrude outwardly through holes in a substantially cylindrical sidewall of the nose 40. The spring-biased protruding members or balls 42 can have diameters that are slightly larger than the diameters of the respective holes of the nose 40 so that the balls do not fall outwardly through those holes. The cavity of the mounting receptacle 50 can be configured for removably receiving the nose 40, and the annular groove 58 can be configured for removably receiving outer portions of the balls 42. Correspondingly, the nose 40 can be configured to be received within the cavity of the mounting receptacle 50, and the balls 42 can be biased outwardly and configured for protruding into the annular groove 58 to retain the base 22 in engagement with the mounting receptacle in a conventional manner. The balls or protruding members 42 are urged outwardly to an engaging position, for extending into and engaging the annular groove 58.

Referring to FIG. 2A, rotational axes in addition to the axes 30, 32, 34 can be associated with the swivel connector 20. For example, in one embodiment, while the base 22 is attached to the mounting receptacle 50, there can be relative rotation between the base and mounting receptacle. More specifically, the mounting receptacle 50 and base 22 can be cooperatively configured so that the balls 42, or other suitable protruding members or bearing-like features, can roll or rotate within the groove 58. More specifically, the groove 58 can be configured generally as a ball race for allowing the balls 42 to roll therein. The rolling/rotational movement of the balls 42 within the annular groove 58 can allow for relative rotation between the base 22 and mounting receptacle 50 while the base is coupled to the mounting receptacle.

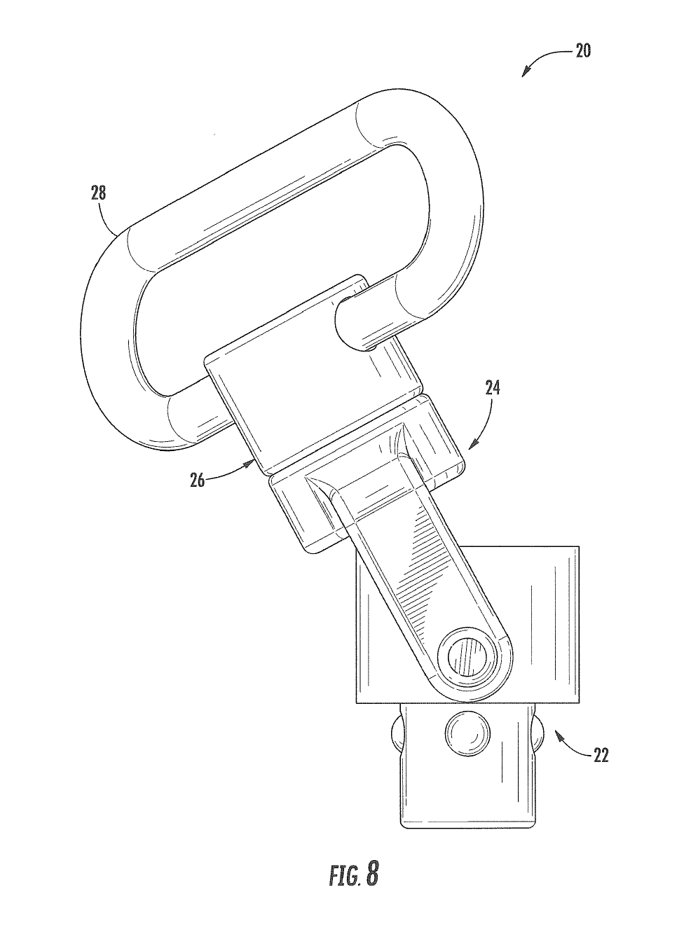

Referring to FIG. 9, the base 22 can include a substantially cylindrical body 44 having opposite ends, one of which is generally open, and the other of which is substantially closed by the nose 40 being fixedly mounted thereto or extending therefrom, or the like. The base 22 can further include an actuator comprising a release button 46 having an outer end that is accessible at the open end of the base body 44. The outer end of the button 46 can be pressed to allow the balls, protruding members 42, or other suitable features, to at least partially retract to a retracted position so that the base 22 can be disconnected and removed from the mounting receptacle 50. More specifically, the button 46 and balls 42 can be cooperatively configured in a conventional manner so that the balls are capable of at least partially retracting into the interior of the nose 40 in response to the button 46 being manually pressed and the base 22 being simultaneously pulled away from the mounting receptacle 50. As examples, the mounting receptacle 50 can be defined in a portion of a firearm 52 (FIGS. 2A and 2B), or can be defined by a sling mount, adaptor, or other suitable structures mounted to a firearm. Alternatively, the quick-disconnect fastener features of the base 22 may be omitted, and the base body 44 can be attached to an article, such as a firearm 52, with at least one fastener, such as a screw, bolt or other suitable fastener.

The body 44 of the base 22 can include a variety of features for at least partially facilitating the pivotable connection between the base 22 and bracket 24 (FIGS. 1-3). As shown in FIG. 9, these connection features can be in the form of lateral mounting holes 60 in the base body 44, wherein these lateral mounting holes 60 can extend through opposite sides of a substantially cylindrical sidewall 62 of the base body 44, as will be discussed in greater detail below. The button 46 is typically recessed within, or can protrude from, an end opening defined by an annular end of the sidewall 62.

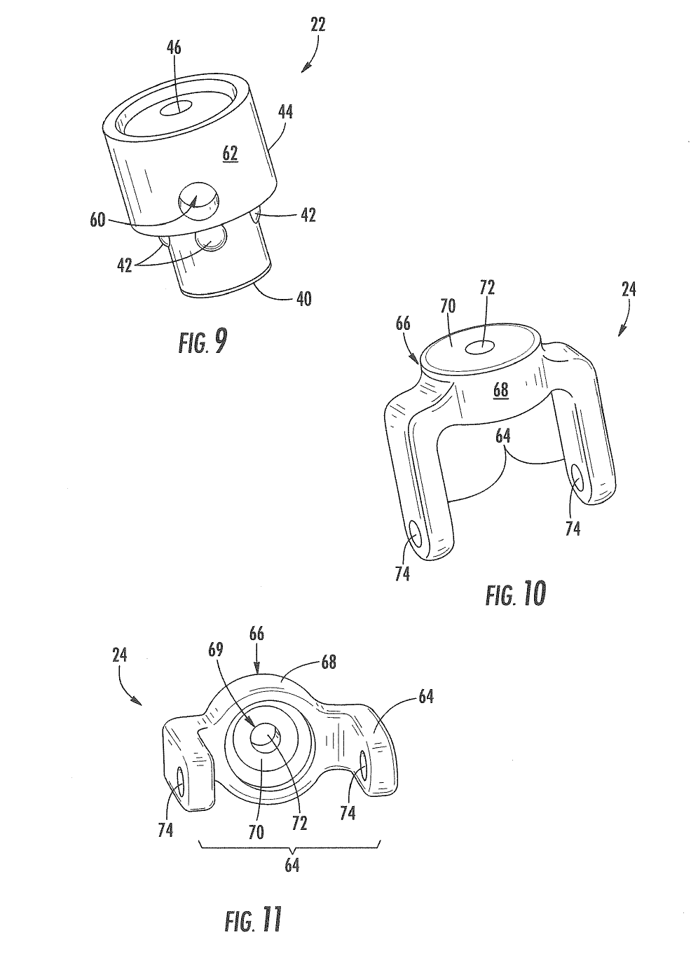

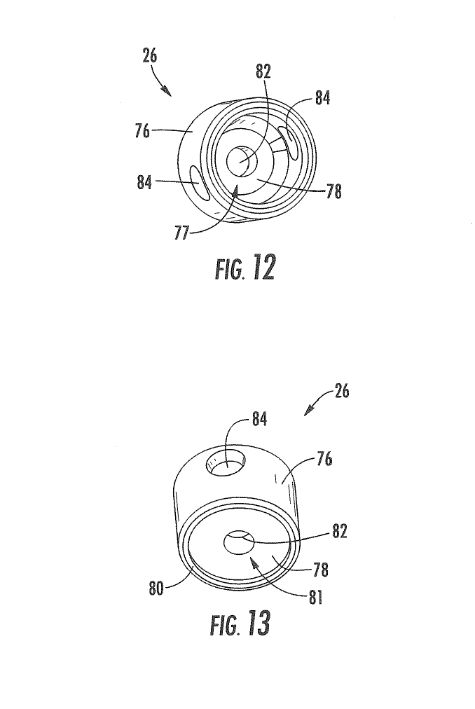

Referring to FIGS. 10 and 11, the bracket 24 can include a pair of protrusions, which can be referred to as appendages 64, extending away from a body 66 of the bracket. In the embodiment shown in FIGS. 11 and 12, the bracket body 66 can be substantially in the form of a socket, so that the bracket body includes a substantially cylindrical sidewall 68 extending around a socket cavity 69, and the bracket body further includes an endwall 70 obstructing an end of the socket cavity.

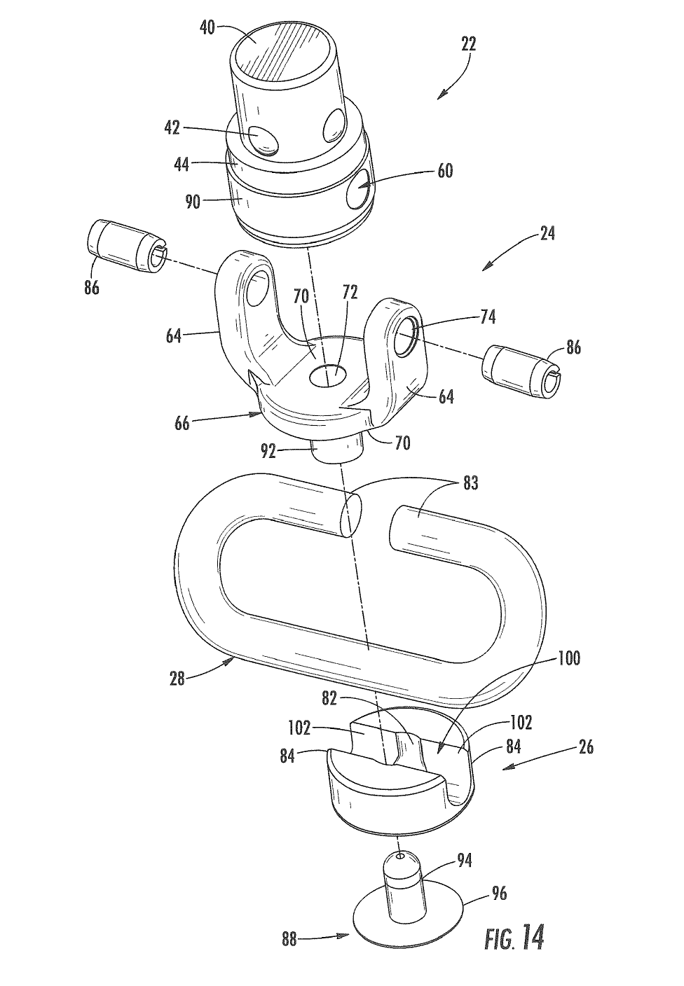

The bracket 24 can include a variety of features for at least partially facilitating the pivotable connection between the bracket and the base 22, and between the bracket and the link 26. As shown in FIGS. 10 and 11, these connection features can include a centrally located mounting hole 72 extending through the endwall 70. Also for facilitating connecting, the appendages 64 can include at least one bend, so that each appendage includes an inner section extending radially outwardly from the outer surface of the sidewall 68, and an outer section extending longitudinally away from the inner section and the bracket body 66. In the embodiments shown in the drawings, the outer sections of the appendages 64 are configured for receiving the base body 44 (FIGS. 12 and 13) therebetween. For example, the outer sections of the appendages 64 can be spaced apart from one another so that a gap is positioned therebetween, and the base 22 extends at least into this gap. Lateral mounting holes 74 can extend through outer end sections of the appendages 64, so that the lateral mounting holes 74 are proximate outer ends of the appendages, for at least partially facilitating the pivotable connection between the bracket 24 and the base 22, as will be discussed in greater detail below.

Referring to FIGS. 12 and 13, the link 26 can be formed as a socket, with a body of the link including a substantially cylindrical sidewall 76 extending around a socket cavity 77 of the link, and the body of the link further includes an endwall 78 obstructing an end of the socket cavity of the link. The body of the link 26 can further include an annular rim 80 extending outwardly from the outer surface of the endwall 78 to define a minor cavity 81 on an underside surface or base of the link 26.

The link 26 also can include a variety of features for at least partially facilitating the pivotable connection between the link and the bracket 24, and between the link and the loop 28. For example, in the embodiments shown in the drawings, a centrally located mounting hole 82 extends through the endwall 78, and opposite lateral mounting holes 84 extend through opposite sides of the sidewall 76.

Referring, for example, to FIG. 1, the loop 28, like the other components of the swivel connector 20, can be made of metal or other suitable materials. More specifically, the loop 28 can be a length of substantially rigid metal wire that has been bent so that opposite ends portions 83 of the loop are coaxial with one another and respectively extend at least into or through the lateral mounting holes 84 of the link 26. The pivotable connection between the link 26 and loop 28 can be at least partially defined by the opposite end portions 83 of the loop 28 respectively extending at least into the one or more lateral mounting holes 84, wherein the diameter of the wire, or the like, that forms the loop is smaller than the diameter of the lateral mounting holes 84. Alternatively, the discontinuous loop 28 can be replaced with a continuous loop, such as a continuous loop in the form of a split ring that extends pivotably through one or more lateral mounting holes 84 of the link 26. Reiterating from above for the embodiments shown in the drawings, the loop 28 typically extends at least partially around a hole (“loop hole”), wherein the loop 28 can be configured to have the conventional clip fastener 29 (FIG. 3), such as a carabiner, attached thereto by virtue of at least a portion of the clip fastener extending through the loop hole and/or the loop hole can be configured for having the conventional strap 29 (FIG. 3) extend therethrough, such as a sling strap.

With continued reference to FIG. 1, the swivel connector 20 can further include one or more fasteners, such as lateral and axial fasteners 86, 88, for at least partially defining the pivotable connections between one or more of the parts 22, 24, 26, 28. For example, in the embodiments shown in the drawings, the pivotable connection between the base 22 and bracket 24 can include lateral fasteners 86, and the pivotable connection between the bracket 24 and link 26 can include axial fastener 88, although a variety of differently configured pivotable connections are within the scope of this disclosure.

Each of the lateral fasteners 86 can include a shaft extending from a head. The shafts of the lateral fasteners 86 can extend through the lateral mounting holes 74 of the bracket 74 and at least into the lateral mounting holes 60 of the base 22. For the shaft of each fastener 86, relative dimensions, or the like, can be defined so that the shaft can be fixedly mounted in one of the lateral mounting holes 60, 74, and there can be relative rotation between the shaft and the other of the lateral mounting holes 60, 74. For example, the lateral fasteners 86 can be screws, bolts, pins, spring pins or any other suitable fasteners. The lateral fasteners 86 can be generally described as being parts of the base 22 and/or the bracket 74.

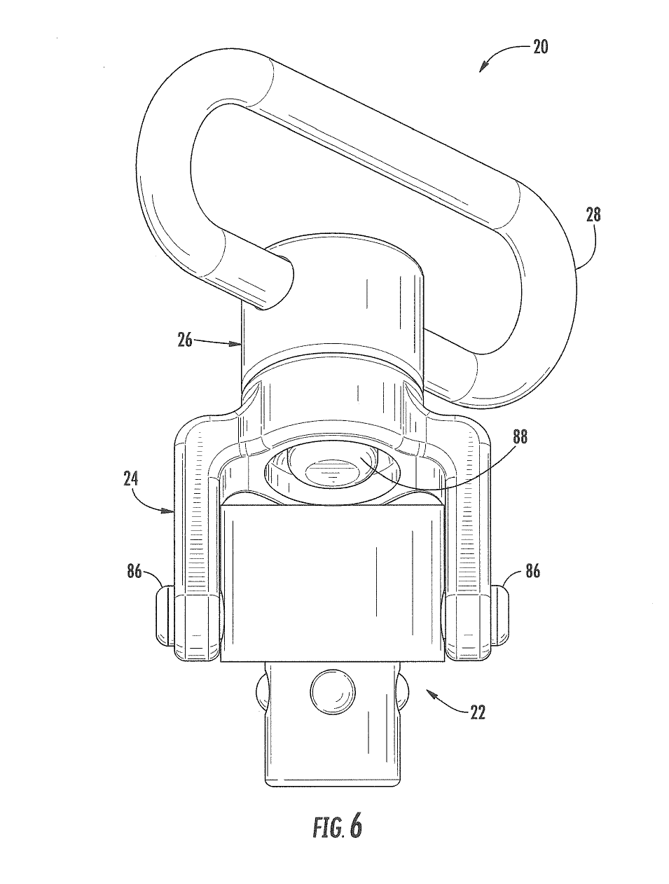

Referring to FIGS. 1, 6 and 7, the axial fastener 88 can include a shaft and heads respectively at the opposite ends of the shaft. Referring also to FIGS. 11-14, the shaft of the axial fastener 88 can extend rotatably through each of the mounting holes 72, 82 of the bracket 24 and link 26. The heads of the axial fastener 88 can be respectively rotatably positioned in the socket cavities 69, 77 of the bracket 24 and link 26. The heads of the axial fastener 88 are wider than the diameter of the mounting holes 72, 82 of the bracket 24 and link 26. The distance between the heads of the axial fastener 88 can be small enough so that the outer surface of the endwall 70 of the bracket 24 is encircled by the rim 80 of the link 26, and there can be at least some sliding contact between the endwall 70 of the bracket 24 and the endwall 78 of the link 26. Referring to FIGS. 1 and 7, the loop 28 can be discontinuous so that its opposite ends 83 are spaced apart from one another and a gap is defined therebetween, and the axial fastener 88 can extend into that gap.

Referring to FIGS. 2A and 3, and as generally discussed above, in one example of the swivel connector 20 being used, the base 22 can be releasably mounted to the conventional firearm 52, such as through the use of the mounting receptacle 50, and the conventional sling strap 29 can be connected to the loop 28, such as discussed above (e.g., directly or by way of a conventional fastener clip 29). More generally, the swivel connector 20 can be used in a wide variety of different ways and/or with a wide variety of different articles.

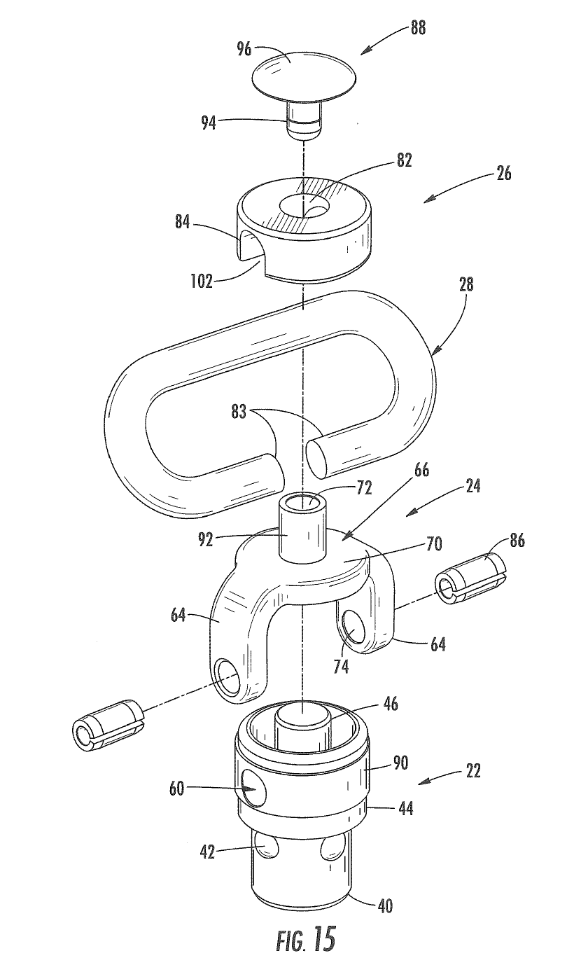

Referring to an embodiment of the swivel connector 20 shown in FIGS. 14 and 15, the base 22 can further include an annular band 90 that extends around and is mounted to, or is an integral part of, the base body 44. The band 90 can be referred to as being part of the base body 44. The band 90 can at least partially define the lateral mounting holes 60 that are configured to receive spring pins 86 or any other suitable fasteners. The body 66 of the bracket 24 can further include a tubular extension 92 extending from the wall 70 and through which the mounting hole 72 extends. The extension 92 can extend through the central mounting hole 82 of the link 26. The shaft 94 of the axial fastener 88 can extend into the mounting hole 72 of the extension 92 in a manner so that there is an interference fit, press fit, friction fit and/or other suitable connection between the extension 92 and the shaft 94, and the link 26 is positioned between the flanged head 96 of the axial fastener 88 and the wall 70 of the bracket 24.

Referring primarily to FIG. 14, the lateral mounting holes 84 of the link 26 can be opposite end openings 84 of a compound passageway or hole 100. The compound hole 100 can further include an end section of the central mounting hole 82 positioned between a pair of mounting openings 102. In the embodiment of FIG. 14, the pair of mounting openings 102 are open toward the wall 70 of the bracket 24 and positioned on opposite sides of the central mounting hole 82. During assembly of the swivel connector 20, the end portions 83 of the preformed loop 28 can be conveniently introduced into respective portions of the compound hole 100 by way of the pair of mounting openings 102, such that bending of the loop 28 may not be required during final assembly of the swivel connector. In the embodiment shown in FIGS. 14 and 15, after the swivel connector 20 is fully assembled, the wall 70 of the bracket 24 obstructs the pair of mounting openings 102 to maintain the end portions 83 of the preformed loop in the end openings 84 of the compound hole 100. Therefore, the wall 70 of the bracket 24 can be described as partially forming the pivotable connection between the link 26 and loop 28. Alternatively, each of the above-discussed connections may be formed in other suitable manners.

The foregoing description generally illustrates and describes various embodiments of the present invention. It will, however, be understood by those skilled in the art that various changes and modifications can be made to the above-discussed construction of the present invention without departing from the spirit and scope of the invention as disclosed herein, and that it is intended that all matter contained in the above description or shown in the accompanying drawings shall be interpreted as being illustrative, and not to be taken in a limiting sense. Furthermore, the scope of the present disclosure shall be construed to cover various modifications, combinations, additions, alterations, etc., above and to the above-described embodiments, which shall be considered to be within the scope of the present invention. It therefore will be understood by those skilled in the art that while the present invention has been described above with reference to examples of embodiments, numerous variations, modifications, and additions can be made thereto without departing from the spirit and scope of the present invention as set forth in the following claims. Accordingly, various features and characteristics of the present invention as discussed herein may be selectively interchanged and applied to other illustrated and non-illustrated embodiments of the invention, and numerous variations, modifications, and additions further can be made thereto without departing from the spirit and scope of the present invention as set forth in the appended claims.

What is claimed is:

1. A swivel connector for connecting a sling to an article, the swivel connector comprising:
first, second, third and fourth parts of the swivel;
a first connection between the first and second parts, the first connection being configured so that there can be relative rotation between the first and second parts about a first axis of rotation;
a second connection between the second and third parts, the second connection being configured so that there can be relative rotation between the second and third parts about a second axis of rotation, the first and second axes extending crosswise to one another; and
a third connection configured so that there can be relative rotation between the third and fourth parts about a third axis of rotation, the second and third axes extending crosswise to one another;
wherein the fourth part is configured to be at least indirectly connected to a sling.

2. The swivel connector of claim 1, wherein the swivel connector is configured so that:
an angle is defined between the first and second parts, the angle between the first and second parts extends substantially perpendicularly to the first axis, a size of the angle between the first and second parts varies in response to relative pivoting about the first axis between the first and second parts, and relative rotation between the first and second parts about the first axis is restricted to less than 360 degrees;
an angle is defined between the third and fourth parts, the angle between the third and fourth parts extends substantially perpendicularly to the third axis, a size of the angle between the third and fourth parts varies in response to relative pivoting about the third axis between the third and fourth parts, and relative rotation between the third and fourth parts about the third axis is restricted to less than 360 degrees; and
relative rotation of at least 360 degrees is allowed between the second and third parts about the second axis.

3. The swivel connector of claim 1, wherein the fourth part comprises a loop configured to be at least indirectly connected to a sling.

4. The swivel connector of claim 3, wherein:
the third part comprises a body defining first and second holes positioned opposite from one another; and
the loop extends at least into the first and second holes.

5. The swivel connector of claim 4, wherein:
the loop is a discontinuous loop having opposite first and second ends portions that are spaced apart from one another so that a gap is defined between the first and second end portions;
the third connection is comprised of the first and second end portions respectively extending at least into the first and second holes; and
the second connection includes a fastener extending at least into the gap.

6. The swivel connector of claim 5, wherein:
the body of the third part further defines a third hole positioned between the first and second holes and adjacent to the gap between the first and second end portions; and
the fastener extends through the third hole.

7. The swivel connector of claim 1, wherein the first part comprises a fastener configured to be at least indirectly connect to an article.

8. The swivel connector of claim 7, wherein the fastener is a quick-disconnect fastener comprising:
protruding members biased outwardly toward an engaging position; and
an actuator configured to cause the protruding members to become at least partially retractable into a body of the first part.

9. The swivel connector of claim 8, wherein:
a body of the first part defines first and second holes positioned opposite from one another; and
the first connection is comprised of first and second portions of the second part respectively extending at least into the first and second holes.

10. The swivel connector of claim 9, wherein:
the first and second portions are first and second fasteners;
the second part comprises a body and first and second appendages extending away from the body and spaced apart from one another so that a gap is positioned between the first and second appendages;
the first part extends at least into the gap between the first and second appendages; and
the first connection is comprised of the first and second fasteners being respectively connected to the first and second appendages.

11. A swivel connector for connecting a sling to a firearm, the swivel connector comprising:
first, second, third and fourth parts of the swivel connector;
a first connection between the first and second parts, the first connection being configured so that there can be relative rotation between the first and second parts about a first axis of rotation;
a second connection between the second and third parts, the second connection being configured so that there can be relative rotation between the second and third parts about a second axis of rotation, the first and second axes extending crosswise to one another; and
a third connection configured so that there can be relative rotation between the third and fourth parts about a third axis of rotation, the second and third axes extending crosswise to one another;
wherein the first part comprises a quick-disconnect fastener configured to be at least indirectly connect to a firearm, and
wherein the fourth part comprises a loop configured to be at least indirectly connected to a sling.

12. The swivel connector of claim 11, wherein the quick-disconnect fastener comprises:
protruding members biased outwardly toward an engaging position; and
an actuator configured to cause the protruding members to become at least partially retractable into a body of the first part.

13. The swivel connector of claim 12, wherein:
a body of the first part defines first and second holes positioned opposite from one another; and
the first connection is comprised of first and second portions of the second part respectively extending at least into the first and second holes.

14. The swivel connector of claim 13, wherein:
the first and second portions are first and second fasteners;
the second part comprises a body and first and second appendages extending away from the body and spaced apart from one another so that a gap is positioned between the first and second appendages;
the first part extends at least into the gap between the first and second appendages; and
the first connection is comprised of the first and second fasteners being respectively connected to the first and second appendages.

15. The swivel connector of claim 11, wherein:
the third part comprises a body defining first and second holes positioned opposite from one another; and
the loop extends at least into the first and second holes.

16. The swivel connector of claim 15, wherein:
the loop is a discontinuous loop having opposite first and second ends portions that are spaced apart from one another so that a gap is defined between the first and second end portions;
the third connection is comprised of the first and second end portions respectively extending at least into the first and second holes; and
the second connection includes a fastener extending at least into the gap.

17. The swivel connector of claim 16, wherein:
the body of the third part further defines a third hole positioned between the first and second holes and adjacent to the gap between the first and second end portions; and
the fastener extends through the third hole.

18. The swivel connector of claim 11, wherein the swivel connector is configured so that:
an angle is defined between the first and second parts, the angle between the first and second parts extends substantially perpendicularly to the first axis, a size of the angle between the first and second parts varies in response to relative pivoting about the first axis between the first and second parts, and relative rotation between the first and second parts about the first axis is restricted to less than 360 degrees;
an angle is defined between the third and fourth parts, the angle between the third and fourth parts extends substantially perpendicularly to the third axis, a size of the angle between the third and fourth parts varies in response to relative pivoting about the third axis between the third and fourth parts, and relative rotation between the third and fourth parts about the third axis is restricted to less than 360 degrees; and
relative rotation of at least 360 degrees is allowed between the second and third parts about the second axis.
